(19) United States
(12) Patent Application Publication
(10) Pub. No.: US 2009/0259658 A1
(43) Pub. Date: Oct. 15, 2009

(54) APPARATUS AND METHOD FOR STORING AND RETRIEVING FILES

(75) Inventors: Yong-ho HWANG, Seoul (KR); Sang-bum Suh, Seoul (KR); Sang-dok Mo, Hwaseong-si (KR); Sung-min Lee, Suwon-si (KR); Bok-deuk Jeong, Yongin-si (KR)

Correspondence Address: MCNEELY BODENDORF LLP, P.O. BOX 34175, WASHINGTON, DC, 20043, US

(73) Assignee: Samsung Electronics Co., Ltd., Suwon-si (KR)

(21) Appl. No.: 12/367,735

(22) Filed: Feb. 9, 2009

(30) Foreign Application Priority Data
Apr. 14, 2008 (KR) 2008-34160

(51) Int. Cl. G06F 7/06; G06F 17/30

(52) U.S. Cl. 707/6; 707/E17.016

(57) ABSTRACT

An apparatus and a method for storing and retrieving files, the apparatus including a menu generation unit to generate a retrieval menu screen to input a retrieval condition, a token generation unit to generate a token by hashing at least one retrieval condition which is input through the retrieval menu screen, and a file retrieval unit to retrieve files matching the retrieval condition by comparing the generated token with each file information included in at least one file to be retrieved.

### CROSS-REFERENCE TO RELATED APPLICATIONS

This application claims the benefit of Korean Application No. 2008-34160, filed in the Korean Intellectual Property Office on Apr. 14, 2008, the disclosure of which is incorporated herein by reference.

### BACKGROUND OF THE INVENTION

1. Field of the Invention

Aspects of the present invention relate to an apparatus and a method for storing and retrieving files, and more particularly, to a file storing/retrieving apparatus which hashes and stores detailed information on files, and retrieves files by hashing a plurality of conditions for retrieval, and a method for storing and retrieving files.

2. Description of the Related Art

Recently, in order to prevent exposure of information or invasion of privacy, technology for storing files in a portable storage device by hiding and encrypting their file names as well as the files has been researched and developed vigorously. Generally, in order to secure a document, the document should be encrypted and stored, and decoded when necessary.

In a conventional process for securing documents, file names are encrypted separately and stored when files are encrypted and stored. Accordingly, if a user retrieves a desired file from among the encrypted files, the encrypted file names are decoded individually and then the desired file name is found. Subsequently, the desired file corresponding to the desired file name is decoded.

In this case, the encrypted file name is larger than the original file name. Since encrypted file names should be decoded individually in order to retrieve the desired file, it may take a long time to decode all the file names. The more files are encrypted, the longer the time taken to retrieve a file. Furthermore, in the conventional process, retrieval can be carried out using only a file name, so information such as the decoded file name may be easily exposed to the outside. Therefore, there is a need for processes to allow the user to store and retrieve files with greater efficiency.

### SUMMARY OF THE INVENTION

An aspect of the present invention provides a file storing/retrieving apparatus which enables a user to retrieve a desired file without decoding file names and to retrieve a file using retrieval conditions other than a file name, and a method for storing and retrieving a file.

Another aspect of the present invention provides a file storing/retrieving apparatus which stores detailed information on a file, such as a file name, using a hash function without exposing the detailed information, and stores a plurality of items of detailed information for more detailed retrieval, and a method for storing and retrieving a file.

According to an aspect of the present invention, a file storing/retrieving apparatus is provided. The file storing/retrieving apparatus includes a menu generation unit to generate a retrieval menu screen to input a retrieval condition, a token generation unit to generate a token by hashing at least one retrieval condition input through the retrieval menu screen, and a file retrieval unit to retrieve files matching the retrieval condition by comparing the generated token with file information included in at least one file to be retrieved.

According to another aspect of the present invention, in a retrieval mode, the menu generation unit generates the retrieval menu screen, the retrieval menu screen including a plurality of retrieval fields which are classified for retrieval and a plurality of areas which receive input of the retrieval condition corresponding to each retrieval field.

According to another aspect of the present invention, the token generation unit generates the token by calculating a final hash value and combining the calculated final hash value and an identifier of the retrieval field corresponding to the retrieval condition, and the token generating unit calculates the final hash value by hashing the retrieval condition which is input into at least one retrieval field from among the plurality of retrieval fields.

According to another aspect of the present invention, if a plurality of retrieval conditions is input, the token generation unit calculates the final hash value by calculating a temporary hash value for each retrieval condition, and applying a logical operation to the calculated temporary hash value.

According to another aspect of the present invention, the local operation is an XOR operation and/or an OR operation selectable by a user.

According to another aspect of the present invention, when the at least one file is stored in a secure mode, the menu generation unit generates a security menu screen, the security menu screen including a plurality of retrieval fields used in the retrieval mode and a plurality of areas to receive input of detailed information corresponding to each retrieval field.

According to another aspect of the present invention, the apparatus further includes a file information generation unit to generates the file information based on each retrieval field by hashing the detailed information input into the at least one retrieval field of the plurality of retrieval fields.

According to another aspect of the present invention, if the at least one file is stored in an advanced secure mode, the file information generation unit generates the file information according to each retrieval field by generating a random number, adds the generated random number to the at least one file, and hashes the generated random number and the detailed information input into the at least one retrieval field of the plurality of retrieval fields.

According to another aspect of the present invention, the token generation unit calculates a final hash value by hashing the retrieval condition which is input into at least one retrieval field from among the plurality of retrieval fields and the random number which is added to the at least one file, and generates the token by combining the calculated final hash value and the identifier of the retrieval field corresponding to the retrieval condition.

According to another aspect of the present invention, the file retrieval unit identifies the identifier of the retrieval field which is included in the token, and compares the final hash value included in the token with file information of a retrieval field corresponding to the identified identifier in the at least one file.

According to another aspect of the present invention, the apparatus further includes a user input unit to output a signal requesting storing of the at least one file in the secure mode and/or a signal requesting retrieval of the at least one file, and a display unit to display the security menu screen and/or the retrieval menu screen which the menu generation unit generates in response to the output request signal.

According to another embodiment of the present invention, a method of storing and retrieving a file is provided. The method includes generating a retrieval menu screen to input a retrieval condition, generating a token by hashing at least one retrieval condition input through the retrieval menu screen, and retrieving files matching the retrieval condition by comparing the generated token with file information included in at least one file to be retrieved.

According to another aspect of the present invention, the generating of the token includes calculating a final hash value by hashing the retrieval condition which is input into at least one retrieval field from among the plurality of retrieval fields, and generating the token by combining the calculated final hash value and an identifier of the retrieval field corresponding to the retrieval condition.

According to an aspect of the present invention, the generating of the token includes calculating a temporary hash value for each retrieval condition if a plurality of retrieval conditions are input, calculating the final hash value by applying a logical operation to each calculated temporary hash value, and generating the token by combining the calculated final hash value and the identifier of the retrieval field corresponding to each retrieval condition.

According to another aspect of the present invention, when the at least one file is stored in a secure mode, the method further includes generating and displaying a security menu screen, the security menu screen including a plurality of retrieval fields used in the retrieval mode and a plurality of areas to receive input of detailed information corresponding to each retrieval field; receiving input of detailed information into the at least one retrieval field; generating the file information according to each retrieval field by hashing the detailed information input into the at least one retrieval field of the plurality of retrieval fields; adding the file information generated according to each retrieval field to the at least one file; and storing the at least one file to which the file information is added.

According to another aspect of the present invention, if the at least one file is stored in an advanced secure mode, the method further includes generating a random number and adding the generated random number to the at least one file, and generating the file information for each retrieval field by hashing the generated random number and the detailed information input into the at least one retrieval field of the plurality of retrieval fields.

According to another aspect of the present invention, the generating of the token includes calculating a final hash value by hashing the retrieval condition input into at least one retrieval field from among the plurality of retrieval fields, and the random number which is added to the at least one file; and generating the token by combining the calculated final hash value and the identifier of the retrieval field corresponding to the retrieval condition.

According to another aspect of the present invention, the retrieving of the files includes identifying the identifier of the retrieval field which is included in the token and comparing the final hash value included in the token and file information of a retrieval field corresponding to the identified identifier in the at least one file.

According to another aspect of the present invention, the method further includes receiving a signal requesting storage of the at least one file in the secure mode and/ot a signal requesting retrieval of the at least one file, and displaying the security menu screen and/or the retrieval menu screen in response to the received request signal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a file storing/retrieving apparatus according to an embodiment of the present invention;

FIG. 2 illustrates a file storing/retrieving apparatus according to another embodiment of the present invention;

FIG. 3 illustrates an example of a security menu screen;

FIG. 4 illustrates an example of a file generated by a file encryption unit when a general secure mode is selected;

FIG. 5 illustrates an example of a file generated by a file encryption unit when an advanced secure mode is selected;

FIGS. 6A and 6B illustrate an example of a retrieval menu screen;

FIG. 7 illustrates a structure of a token generated by a token generation unit;

FIG. 8 is a flow chart of a process for storing a file according to an embodiment of the present invention;

FIG. 9 is a flow chart of a process for retrieving a file in a general retrieval mode according to an embodiment of the present invention;

FIG. 10 is a flow chart of an example of a process for retrieving a file using a token generated in the process of FIG. 9; and

FIG. 11 is a flow chart illustrating a process for retrieving a file in an advanced retrieval mode according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

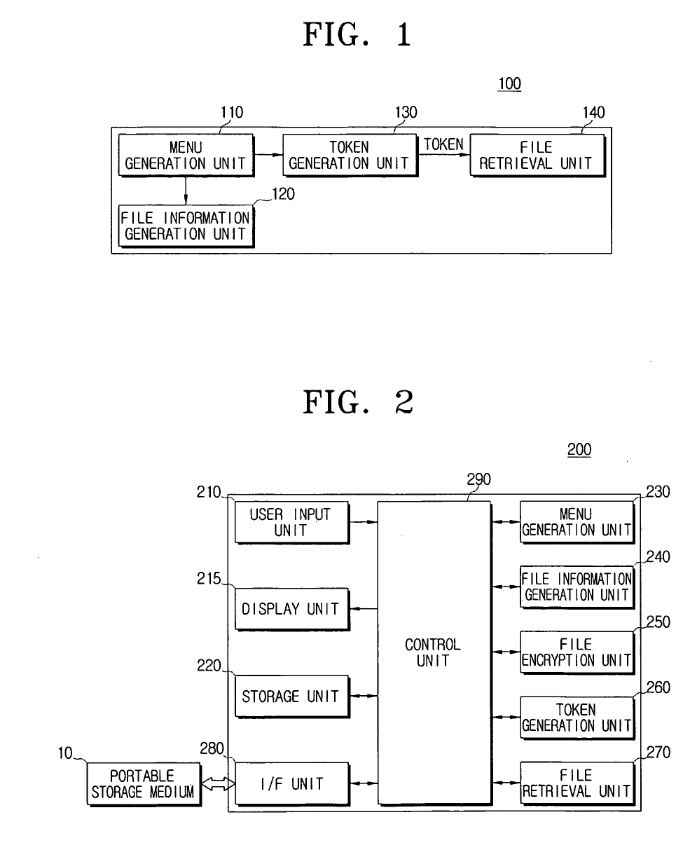

FIG. 1 shows a file storing/retrieving apparatus 100 according to an embodiment of the present invention. The file storing/retrieving apparatus 100 encrypts and stores actual data of a file, and hashes and stores detailed information related to the file, such as the file name and the date on which the file was written. When the encrypted file is retrieved, it is possible to perform retrieval using a hashing function without decoding the detailed information. Accordingly, the file storing/retrieving apparatus 100 includes a menu generation unit 110, a file information generation unit 120, a token generation unit 130, and a file retrieval unit 140. According to other aspects of the present invention, the file storing/retrieving apparatus 100 may include additional and/or different units. Similarly, the functionality of two or more of the above units may be integrated into a single component. The file storing/retrieving apparatus 100, as with other apparatuses according to aspects of the present invention, may be a stand-alone device or part of another computing device, such as a desktop computer, laptop computer, server (or other enterprise computing device), personal digital assistant (PDA), mobile phone, or personal entertainment device.

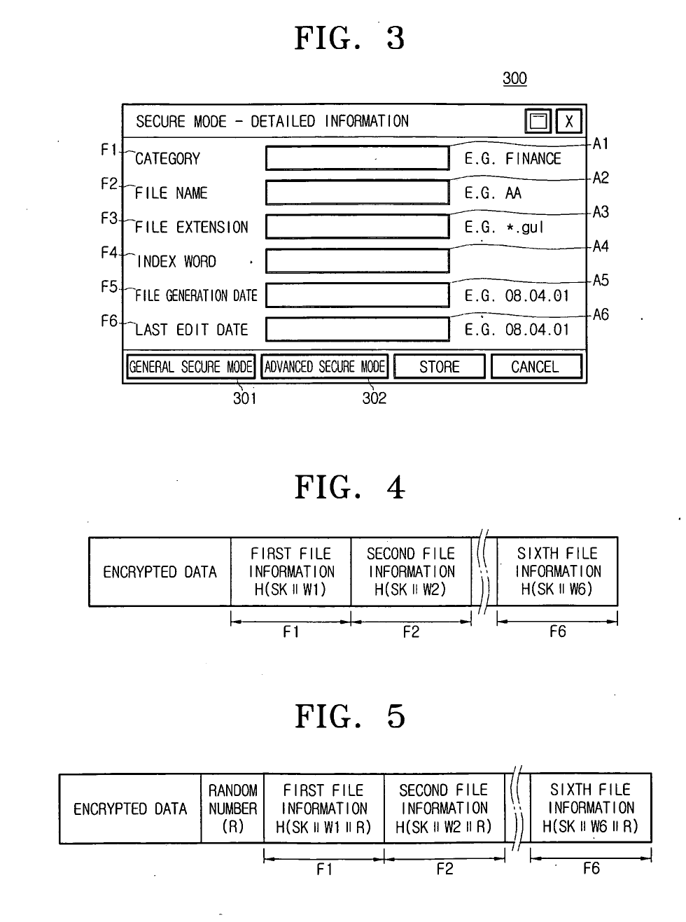

The menu generation unit 110 generates a security menu screen to input detailed information on a file when the file is encrypted and stored, and a retrieval menu screen to retrieve a desired file (referred to hereinafter as a target file) from among at least one encrypted file. The security menu screen and the retrieval menu screen will be described below in more detail with reference to FIGS. 3 and 4.

The file information generation unit 120 calculates hash values by individually hashing at least one item of detailed information input through the security menu screen, and outputs each calculated hash value as file information. The at least one item of file information generated is added to the encrypted file and stored.

The token generation unit 130 calculates hash values by individually hashing at least one retrieval condition input through the retrieval menu screen. Each calculated hash value is used as a token corresponding to each retrieval condition.

The file retrieval unit 140 retrieves a target file matching with the input retrieval condition by comparing the at least one item of file information generated by the file information generation unit 120 with the token generated by the token generation unit 130. The file retrieval unit 140 retrieves a plurality of files in sequence, and compares at least one item of file information contained in a file which is currently being retrieved from among the plurality of files with the token generated by the token generation unit 130. If the at least one item of file information is the same as the token, the file retrieval unit 140 determines that the currently retrieved file is a target file. As a result, the file retrieval unit 140 reports the target file found to the user.

FIG. 2 shows a file storing/retrieving apparatus 200 according to another embodiment of the present invention. The file storing/retrieving apparatus 200 encrypts a file if the file needs to be secured, and hashes and stores detailed information related to the file, such as the file name of the file, so that information regarding the file cannot be leaked to the outside. In addition, when a desired file is retrieved from among the encrypted files, the file storing/retrieving apparatus 200 can perform retrieval without decoding the detailed information. Since retrieval can be performed using a plurality of retrieval conditions, a target file can be retrieved by hashing each retrieval condition input by the user. To this end, the file storing/retrieving apparatus 200 includes a user input unit 210, a display unit 215, a storage unit 220, a menu generation unit 230, a file information generation unit 240, a file encryption unit 250, a token generation unit 260, a file retrieval unit 270, an interface (I/F) unit 280, and a control unit 290.

The user input unit 210 supports the interface between the user and the file storing/retrieving apparatus 200, and outputs a storage request signal to request storage of at least one file in a security mode, and a retrieval request signal to request retrieval of files stored in a security mode. Storing a file in a security mode refers to encrypting data and hashing and storing detailed information on the file. The detailed information on the file includes diverse attribute information related to the file, such as the file name, the category of the file, the date on which the file is written, or a keyword, and is the same as retrieval fields that are used for retrieval.

The display unit 215 selectively displays one of a graphical user interface (GUI) requesting a password, a security menu screen, and a retrieval menu screen, in response to a request signal output from the user input unit 210. In addition, the display unit 215 may display a message indicating that a file has been completely stored, or completely retrieved, so the user can recognize the status of the file.

The storage unit 220 stores a program that supports storing and retrieving files according to aspects of the present invention, and diverse control programs for operating the file storing/retrieving apparatus 200. The storage unit 220 also stores a plurality of encrypted files.

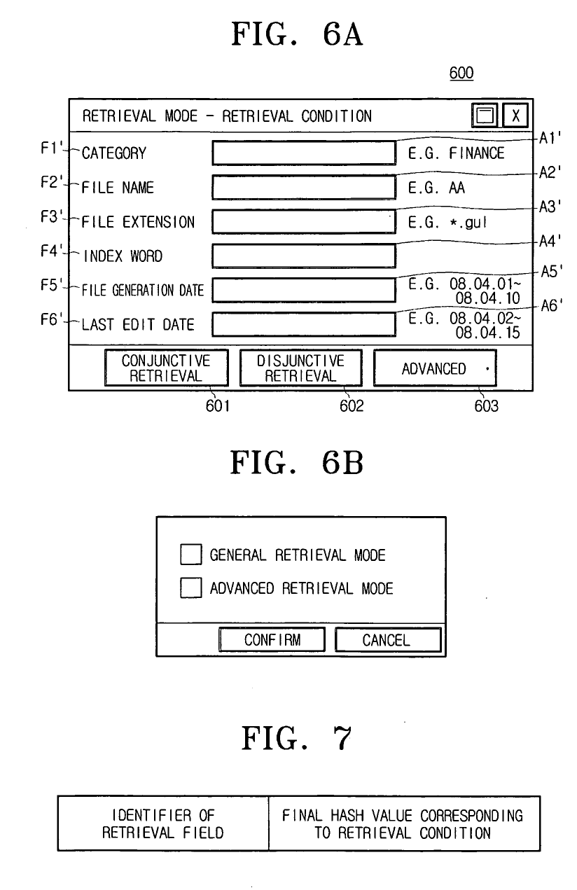

If a storage request signal in a secure mode is output from the user input unit 210, the menu generation unit 230 generates a GUI requesting input of a password, and a security menu screen 300 as shown in FIG. 3. In addition, if a retrieval request signal is output, the menu generation unit 230 generates a GUI requesting input of a password, and a retrieval menu screen 600 as shown in FIG. 6. The security menu screen 300 is a GUI to input detailed information on a file in order to encrypt and store the file. The retrieval menu screen 600 is a GUI to retrieve a desired file from among encrypted files.

With reference to FIG. 3, the security menu screen 300 includes areas A1 to A6 to input detailed information on a file, and attribute fields F1 to F6 to represent each attribute of the detailed information. The attribute fields F1 to F6 are the same as retrieval fields F1′ to F6′ which are used to retrieve files, and the detailed information input in the areas A1 to A6 matching each attribute field F1 to F6 is used in retrieving files. One or more items of detailed information may be input in each area Al to A6.

The attribute field F1 representing “Category” refers to a field to which a file belongs. The attribute field F4 representing “Index word” refers to a keyword of a file. The attribute field F6 representing “Last edit date” refers to a date when a file was last edited and stored. Attribute fields to input additional information related to the file may also be provided.

The user can input detailed information into at least one of the areas A1 to A6 corresponding to the attribute fields F1 to F6 in the security menu screen 300. For example, the user can input the file name “AA” into the area A2 corresponding to the attribute field F2 representing “File name,” and can input “doc” into the area A3 corresponding to the attribute field F3 representing “File extension.” The user need not input information into all of the areas A1 to A6; one or more of the areas A1 to A6 may be left empty.

A general secure mode 301 is selected to hash and store at least one item of detailed information input after a file is input. An advanced secure mode 302 is selected to generate a random number and hash and store at least one item of detailed information together with the random number after a file is encrypted.

The file information generation unit 240 generates file information by hashing the at least one item of detailed information input through the security menu screen 300. As many items of file information are generated as there are attribute fields into which the detailed information is input. The at least one item of generated file information is added to the encrypted file and then stored in the storage unit 220 or a portable storage medium 10.

If the user selects the general secure mode 301, the file information generation unit 240 encrypts actual data of the file and generates file information for attribute fields F1 to F6 into which detailed information is input using Equation 1 below.

File information=H(SK∥W_{N}) [Equation 1]

In Equation 1, the file information is a hash value, H is a hash function, SK is a password input by the user, W_{N} is the detailed information of each attribute field input through the security menu screen 300, and N is a positive integer ranging from 1 to 6 corresponding to the number of attribute fields. The maximum value of N corresponds to the number of attribute fields; thus, in the example described, since the number of attributes fields is 6, the maximum value of N is also 6. W_{N} may include only the input detailed information or may further include an identifier (for example, F1) of an attribute field into which detailed information is input. For example, W_{N} can express “AAA” as a file name, or express “F2:AAA” including an identifier “F2” corresponding to the file name. If W_{N} includes the identifier, the identifier can be used to retrieve the file more efficiently. For example, in a retrieval menu screen, when a retrieval condition which the user inputs into a category field is the same as a retrieval condition which the user inputs into a file name field, if W_{N} does not include the identifier, it takes more time to retrieve a file, and more files may be found.

If the user selects the advanced secure mode 302, the file information generation unit 240 encrypts actual data of a file, generates a random number for the file, and generates file information for attribute fields F1 to F6 into which detailed information is input using Equation 2 below.

File information=R, H(SK∥W_{N}∥R) [Equation 2]

In Equation 2, R is a random number to be added to a file, and the remaining variables are the same as in Equation 1. In order to generate file information in the advanced secure mode, the file information generation unit 240 generates a random number, and hashes the random number, a password, and an item of detailed information, so that file information for one attribute field is generated. In the advanced secure mode, file information for each attribute field into which detailed information is input is generated by performing hashing by applying a random number and a password to Equation 2 for each item of input detailed information. For example, if detailed information is input into attribute fields F1 and F2, the file information generation unit 240 generates first file information for the attribute field F1 and second file information for the attribute field F2 using Equation 2.

The file encryption unit 250 encrypts actual data of a file, and adds at least one item of file information generated by the file information generation unit 240 to the encrypted data, so that an encrypted file is generated. If the general secure mode 301 is selected, a file generated by the file encryption unit 250 has a structure as shown in FIG. 4, in which first to sixth file information is file information corresponding to each attribute field F1 to F6, meaning that the user has input detailed information in the areas Al to A6 of the security menu screen 300.

If the advanced secure mode 302 is selected, a file generated by the file encryption unit 250 has a structure as shown in FIG. 5, in which the file includes an area R for storing a random number, and includes first to sixth items of file information H (SK∥W1∥R), H (SK∥W2∥R), H (SK∥W3∥R), H (SK∥W4∥R), H (SK∥W5∥R), and H (SK∥W6∥R), which is the result of hashing the random number, a password, and detailed information for each attribute. If the user inputs detailed information into area A1 of the security menu screen 300, the file includes the encrypted data, the random number, and the first file information H (SK∥W1∥R).

FIG. 6A shows an example of a retrieval menu screen. In FIG. 6A, the retrieval menu screen 600 includes a plurality of retrieval fields F1′ to F6′ and a plurality of areas A1′ to A6′ to input retrieval conditions corresponding to each retrieval field F1′ to F6′. The retrieval fields F1′ to F6′ may be the same as the attribute fields F1 to F6 of the security menu screen 300, but are not limited thereto.

A conjunctive retrieval 601 is used to retrieve files satisfying a plurality of retrieval conditions. If the user inputs retrieval conditions into two or more areas from among the areas A1′ to A6′, or if the user inputs a plurality of retrieval conditions into one area, the input retrieval conditions are hashed using Equation 1 or Equation 2, and the XOR operation of the results of hashing is performed in order to retrieve a target file. In the XOR operation, if two retrieval conditions are input, files having file information satisfying the two retrieval conditions are found.

A disjunctive retrieval 602 is used to retrieve files satisfying at least one of a plurality of retrieval conditions. If a plurality of retrieval conditions are input, the input retrieval conditions are hashed using Equation 1 or Equation 2, and the OR operation of the results of hashing is performed in order to retrieve a target file. In the OR operation, if two retrieval conditions are input, files having file information satisfying at least one of the two retrieval conditions are found. Accordingly, the number of files retrieved using the disjunctive retrieval may be greater than the number of files retrieved using the conjunctive retrieval. The XOR operation and OR operation are logic calculation schemes, and can be selected by the user through the screen shown in FIG. 6A.

In the retrieval menu screen 600, if an advanced retrieval mode 603 is selected, the menu generation unit 230 generates a GUI as shown in FIG. 6B, which shows a GUI to select whether to proceed with retrieving a file in a general retrieval mode or the advanced retrieval mode 603. The general retrieval mode is used when a random number is not included in an encrypted file, and the advanced retrieval mode is used when a random number is included in an encrypted file.

Referring to FIG. 2 again, the token generation unit 260 calculates each hash value by individually hashing at least one retrieval condition input through the retrieval menu screen. Each calculated hash value is used as a token corresponding to each retrieval condition. If the user input unit 210 inputs a retrieval request signal, the menu generation unit 230 displays a password input screen, and generates the retrieval menu screen 600 as shown in FIG. 6A if the user inputs the password. The display unit 215 displays the retrieval menu screen 600.

If a single retrieval condition is input into the displayed retrieval menu screen 600, the token generation unit 260 calculates a final hash value by putting the input retrieval condition and the password into Equation 1 or Equation 2. For example, in the screen shown in FIG. 6A, if the conjunctive retrieval 601 or the disjunctive retrieval 602 is selected, the token generation unit 260 calculates a final hash value using a random number R included in the file and Equation 2 if a file to be currently retrieved includes the random number. Alternatively, in the screen shown in FIG. 6B, if the advanced retrieval mode is selected, the token generation unit 260 calculates a final hash value using Equation 2. The token generation unit 260 identifies a random number R included in the file to be currently retrieved, and calculates a final hash value using the identified random number R and Equation 2.

If a plurality of retrieval conditions are input into the retrieval menu screen 600, the token generation unit 260 calculates a plurality of temporary hash values by putting each input retrieval condition and password into Equation 1 or Equation 2.Consequently, temporary hash values corresponding to each retrieval condition are calculated. In the retrieval menu screen 600, if the conjunctive retrieval 601 is selected, the token generation unit 260 calculates a final hash value by performing an XOR operation on the calculated plurality of temporary hash values. The result values of the XOR operation are the same as the length of a hash function used for hashing.

Subsequently, the token generation unit 260 generates a token used for retrieval by combining the calculated final hash value and an identifier of each retrieval field into which retrieval conditions are input. FIG. 7 shows a structure of a token generated by the token generation unit 260. The identifiers of the retrieval fields F1′ to F6′ can be expressed using N bits.

For example, in the retrieval menu screen 600 as shown in FIG. 6A, if retrieval conditions “AAA” and “doc” are input into areas A2′ and A3′ corresponding to retrieval fields F2′ and F3′ respectively, and if the conjunctive retrieval 601 is selected, the token generation unit 260 calculates a first temporary hash value for retrieval condition “AAA” using Equation 1, and calculates a second temporary hash value for retrieval condition “doc” using Equation 1. Subsequently, the token generation unit 260 calculates a final hash value by performing an XOR operation on the first and second temporary hash value, and generates “011000” as an identifier of retrieval fields F2′ and F3′. In “011000,” the first “0” represents that a retrieval condition for retrieval field F1′ is not input into area A1′, and “11” represents that retrieval conditions for retrieval fields F2′ and F3′ are input into areas A2′ and A3′.

Referring to FIG. 2 again, the file retrieval unit 270 retrieves a target file matching the input retrieval conditions by comparing at least one item of file information with the token generated by the token generation unit 260. The at least one item of file information refers to file information generated by the file information generation unit 240 and added to a file when storing the file.

When a single retrieval condition is input, the file retrieval unit 270 determines that a file which is currently being retrieved is a target file if at least one item of file information for the currently retrieved file from among a plurality of files is the same as the token generated by the token generation unit 260. When a plurality of retrieval conditions are input, the file retrieval unit 270 identifies at least one identifier contained in the token, and extracts file information corresponding to the at least one identifier from a currently retrieved file. In the retrieval menu screen 600, if the conjunctive retrieval 601 is selected, the file retrieval unit 270 performs an XOR operation on the at least one extracted item of file information and compares the result of operation with a final hash value of the token. If the result of operation is the same as the final hash value of the token, the file retrieval unit 270 determines that the currently retrieved file is a target file, and performs the above process for a subsequent file.

The I/F unit 280 provides a communication interface between a portable storage medium 10 and the file storing/retrieving apparatus 200. The portable storage medium 10 can store encrypted files. The control unit 290 executes a program corresponding to a request for encrypting and storing a file or retrieving a file, and decodes a file and notifies the user of the retrieval result if the file is found.

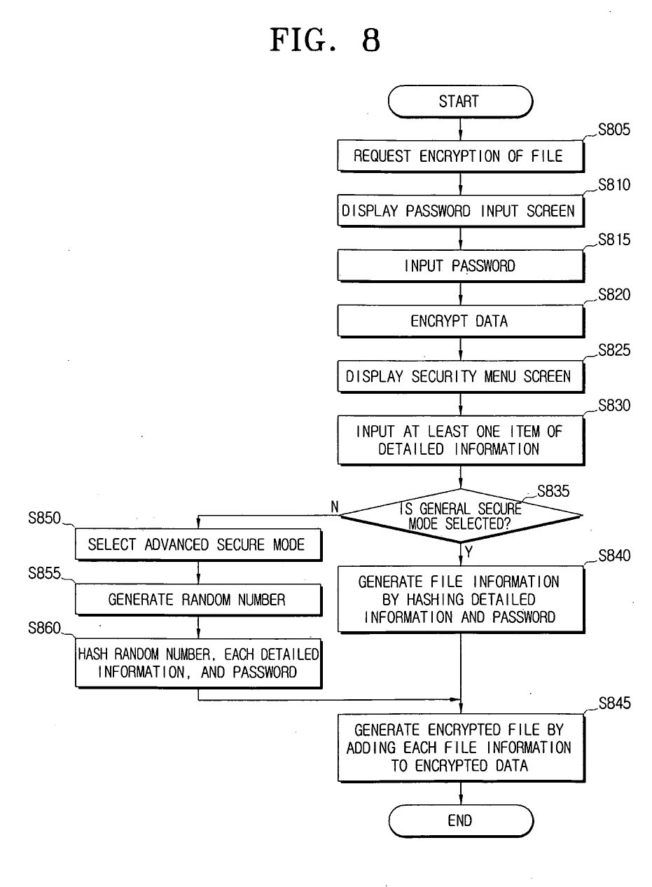

FIG. 8 is a flow chart of a process for storing a file according to an embodiment of the present invention. With reference to FIGS. 1 to 8, when the user requests encryption of a file through the user input unit 210 in operation S805, the menu generation unit 230 generates and displays a password input screen on the display unit 215 in operation S810. The user inputs a password in operation S815, the file encryption unit 250 encrypts data of the file in operation S820, and a security menu screen 300 is generated and displayed in operation S825.

At least one item of detailed information is input into areas A1 to A6 of the security menu screen 300 in operation S830. If a general secure mode 301 is selected in operation S835, then in operation S840 the file information generation unit 240 hashes the password and each item of detailed information using Equation 1 so that at least one item of file information is generated. In operation S845, the file encryption unit 250 adds the at least one item of file information generated in operation S840 to the data encrypted in operation S820, so that a file as shown in FIG. 4.

If an advanced secure mode 302 is selected in operation S850, the file information generation unit 240 generates a random number R in operation S855. In operation S860, the file information generation unit hashes the random number R, the password, and the detailed information using Equation 2.Consequently, as many items of file information are generated as there are items of detailed information input in operation S830. The file encryption unit 250 generates a file as shown in FIG. 5 in operation S845.

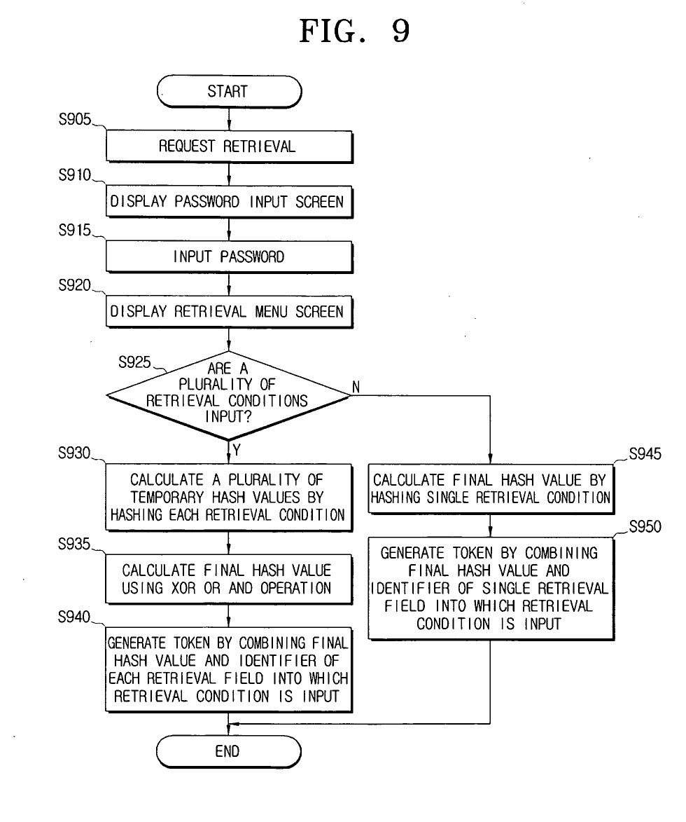

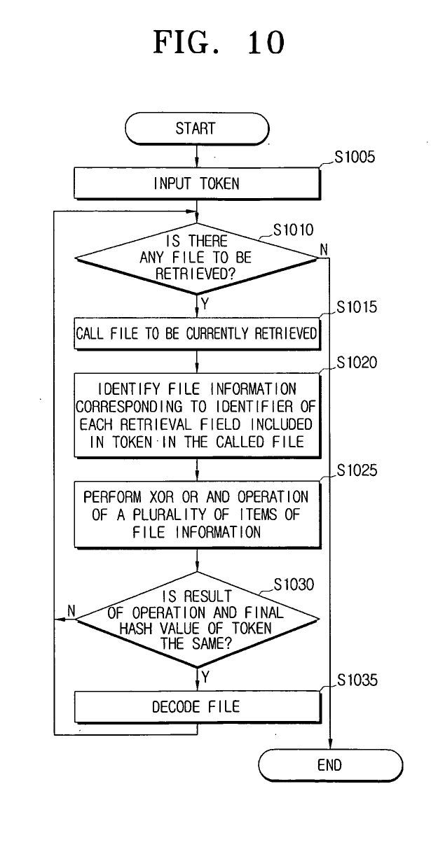

FIG. 9 is a flow chart of a process for retrieving a file in a general retrieval mode according to an embodiment of the present invention. With reference to FIGS. 1 to 9, if the user requests retrieval of a file through the user input unit 210 in operation S905, a password input screen is displayed on the display unit 215 in operation S910, so that the user may input the password in operation 915. The retrieval menu screen 600 is then displayed on the display unit 215 in operation S920.

If a plurality of retrieval conditions is input into the retrieval menu screen 600 in operation S925, the token generation unit 260 calculates a plurality of temporary hash values by hashing each input retrieval condition and password using Equation 1 in operation S930. In the retrieval menu screen 600 displayed in operation S920, if the conjunctive retrieval 601 is selected, the token generation unit 260 performs the XOR operation on the plurality of temporary hash values. If the disjunctive retrieval 602 is selected, the token generation unit 260 performs the OR operation on the plurality of temporary hash values. As a result, a final hash value is calculated in operation S935. The token generation unit 260 generates a token as shown in FIG. 7 by combining an identifier of a retrieval field corresponding to each input retrieval condition with the final hash value calculated in operation S935 in operation S940.

Alternatively, if a single retrieval condition is input into the retrieval menu screen 600, then in operation S945, the token generation unit 260 calculates a final hash value by hashing the single retrieval condition and the password using Equation 1. In operation S950, the token generation unit 260 generates a token as shown in FIG. 7 by combining an identifier of the retrieval field corresponding to the single retrieval condition input in operation S925 with the final hash value calculated in operation S945.

FIG. 10 is a flow chart of an example of a process for retrieving a file using the token generated in the process of FIG. 9. With reference to FIGS. 1 to 10, if the token generated in operation S940 or S950 is input in operation S1005, the file retrieval unit 270 identifies whether there are files to be retrieved in operation S1010. The files to be retrieved can be files in a folder or a directory, which is designated by the user, in the storage unit 220 or the portable storage medium 10.

If there are files to be retrieved, the file retrieval unit 270 calls a file to be currently retrieved in operation S1015. The called file is an encrypted file and has the structure as shown in FIG. 4. The file retrieval unit 270 identifies the identifier of each retrieval field included in the token input in operation S1005, and identifies file information corresponding to the at least one identified identifier in the called file in operation S1020. For example, if the identified identifier is “011000,” the file retrieval unit 270 identifies second and third file information from among at least one item of file information included in the called file, since “011000” indicates that retrieval conditions were input in areas A2′ and A3′ corresponding to retrieval fields F2′ and F3′ in operation S925.

In operation S1025, the file retrieval unit 270 performs an XOR operation or OR operation on each identified file information. The file retrieval unit 270 can omit the XOR or OR operations when only a single item of file information is identified. Alternatively, when a plurality of items of file information is identified, if the conjunctive retrieval 601 is selected in the retrieval menu screen 600, the file retrieval unit 270 performs the XOR operation of the plurality of items of file information.

Subsequently, the file retrieval unit 270 determines in operation S1 030 whether the result of the operation performed in operation S1025 is the same as the final hash value included in the token input in operation S1005. This is because the file information is a hash value calculated by hashing.

If the result of the operation performed in operation S1025 is the same as the final hash value included in the token input in operation S1005, the control unit 290 decodes and temporarily stores the file called in operation S1015 in operation S1035. After operation S1035, the file retrieval unit 270 returns to operation S1010 so as to identify whether there is a file which has not yet been retrieved. If retrieval of all of the files is completed, the control unit 290 notifies the user of the number of files matching the retrieval conditions, and provides the user with the decoded and temporarily stored data if requested. Decoding of a file can be selectively performed.

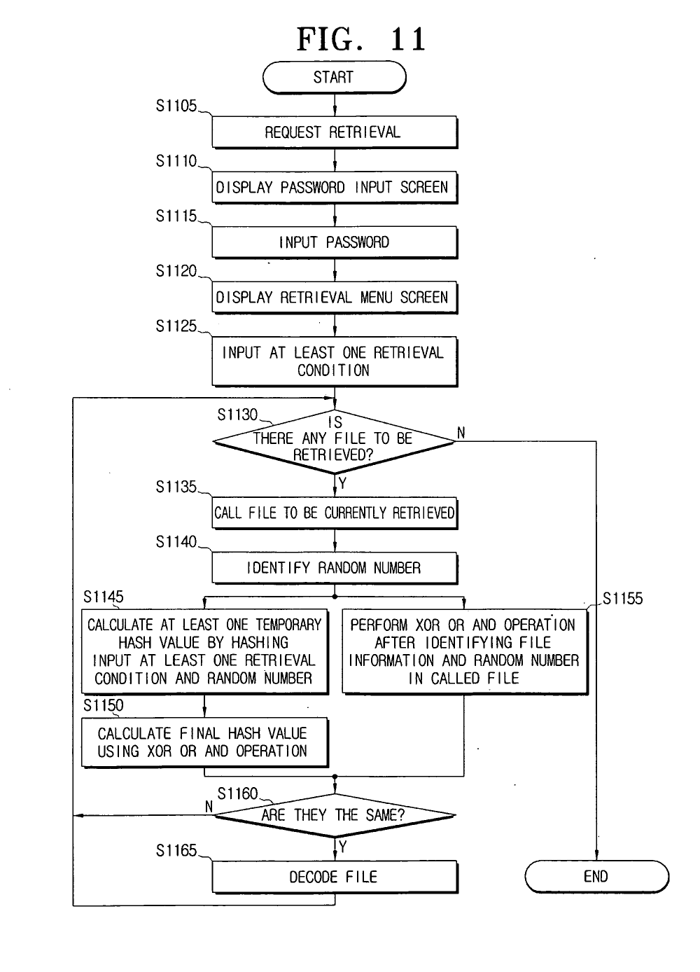

FIG. 11 is a flow chart of a process for retrieving a file in an advanced retrieval mode according to an embodiment of the present invention. With reference to FIGS. 1 to 11, if the user requests retrieval of a file through the user input unit 210 in operation S1105, a password input screen is displayed on the display unit 215 in operation S1110. After the user inputs a password in operation S1115, the retrieval menu screen 600 is displayed on the display unit 215 in operation S1120.

If at least one retrieval condition is input into the retrieval menu screen 600, and an advanced retrieval mode is selected in operation S1125, the file retrieval unit 270 identifies whether or not a folder or a directory which is selected by the user includes files to be retrieved in operation S1130. If there are files to be retrieved, the file retrieval unit 270 calls a file to be currently retrieved in operation S1135. The token generation unit 260 identifies a random number R included in the called file in operation S1140. Random numbers in each file may be the same or different.

The token generation unit 260 calculates a temporary hash value by hashing the retrieval condition input in operation S1125, the random number R, and the password using Equation 2 in operation S1145. If a plurality of retrieval conditions are input in operation S1125, a plurality of temporary hash values are output in operation S1145.

In the retrieval menu screen 600 displayed in operation S1120, if the conjunctive retrieval 601 is selected, the token generation unit 260 performs an XOR operation on the plurality of temporary hash values. If the disjunctive retrieval 602 is selected, the token generation unit 260 performs an OR operation on the plurality of temporary hash values. As a result, a final hash value is calculated in operation S1150.

The file retrieval unit 270 identifies the identifier of each retrieval field into which the retrieval conditions are input in operation S1125, identifies file information corresponding to the at least one identified identifier in the called file, and performs an XOR operation or OR operation on each identified file information in operation S1155. Since operation 1155 is similar to operations S1020 and S1025, detailed description is omitted here.

In operation S1160, the file retrieval unit 270 determines if the result of operations performed in operation S1155 is the same as the final hash value obtained in operation S1150. If the result of operations performed in operation S1155 is the same as the final hash value obtained in operation S1150, then in operation S1165, the control unit 290 decodes and temporarily stores the file called in operation S1135. After operation S1165, the file retrieval unit 270 returns to operation S1130 so as to identify whether there is a file which has not yet been retrieved. If retrieval of all of the files is completed, the control unit 290 notifies the user of the number of files matching the retrieval conditions.

As can be appreciated from the above description of a file storing/retrieving apparatus and a method for storing and retrieving a file according to aspects of the present invention, detailed information on a file is hashed upon encrypting and storing the file, so that encryption and decoding of the detailed information are not needed and a plurality of items of detailed information can be efficiently input. Consequently, files can be retrieved using a plurality of retrieval conditions, resulting in more precise and rapid retrieval.

Furthermore, upon retrieving a file, retrieval conditions are hashed and compared with file information stored with the file, so that it is possible not to expose the file information to the user, resulting in increased file security and file information security. In particular, when a file is stored in an advanced secure mode and retrieval is performed in an advanced retrieval mode, detailed information or retrieval conditions are hashed using a random number included in the file, so that the security of the file can be maintained using an upgraded scheme. Finally, since two or more retrieval conditions can be input into a single retrieval field in a retrieval mode, more diverse and specific retrieval is enabled.

Aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CDs, DVDs, Blu-ray discs, magnetic tapes, floppy disks, and optical data storage devices. Aspects of the present invention may also be embodied as carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A file storing/retrieving apparatus, comprising:
a menu generation unit to generate a retrieval menu screen to input a retrieval condition;
a token generation unit to generate a token by hashing at least one retrieval condition input through the retrieval menu screen; and
a file retrieval unit to retrieve files matching the retrieval condition by comparing the generated token with file information included in at least one file to be retrieved.

2. The apparatus according to claim 1, wherein in a retrieval mode, the menu generation unit generates the retrieval menu screen, the retrieval menu screen comprising a plurality of retrieval fields classified for retrieval and a plurality of areas to receive input of the retrieval condition corresponding to each retrieval field.

3. The apparatus according to claim 2, wherein:
the token generation unit generates the token by calculating a final hash value and combining the calculated final hash value and an identifier of the retrieval field corresponding to the retrieval condition; and
the token generation unit calculates the final hash value by hashing the retrieval condition which is input into at least one retrieval field from among the plurality of retrieval fields.

4. The apparatus according to claim 3, wherein, if a plurality of retrieval conditions is input, the token generation unit calculates the final hash value by calculating a temporary hash value for each retrieval condition, and applying a logical operation to the calculated temporary hash value.

5. The apparatus according to claim 4, wherein the local operation is an XOR operation and/or an OR operation selectable by a user.

6. The apparatus according to claim 1, wherein, when the at least one file is stored in a secure mode, the menu generation unit generates a security menu screen, the security menu screen comprising a plurality of retrieval fields used in the retrieval mode and a plurality of areas to receive input of detailed information corresponding to each retrieval field.

7. The apparatus according to claim 6, further comprising:
a file information generation unit to generate the file information based on each retrieval field by hashing the detailed information input into the at least one retrieval field of the plurality of retrieval fields.

8. The apparatus according to claim 7, wherein, if the at least one file is stored in an advanced secure mode, the file information generation unit generates the file information according to each retrieval field by generating a random number, adds the generated random number to the at least one file, and hashes the generated random number and the detailed information input into the at least one retrieval field of the plurality of retrieval fields.

9. The apparatus according to claim 8, wherein the token generation unit calculates a final hash value by hashing the retrieval condition which is input into at least one retrieval field from among the plurality of retrieval fields and the random number which is added to the at least one file, and generates the token by combining the calculated final hash value and the identifier of the retrieval field corresponding to the retrieval condition.

10. The apparatus according to claim 3, wherein the file retrieval unit identifies the identifier of the retrieval field which is included in the token, and compares the final hash value included in the token with file information of a retrieval field corresponding to the identified identifier in the at least one file.

11. The apparatus according to claim 6, further comprising:
a user input unit to output a signal requesting storage of the at least one file in the secure mode and/or a signal requesting retrieval of the at least one file; and
a display unit to display the security menu screen and/or the retrieval menu screen which the menu generation unit generates in response to the output request signal.

12. A method of storing and retrieving a file, the method comprising:
generating a retrieval menu screen to input a retrieval condition;
generating a token by hashing at least one retrieval condition input through the retrieval menu screen; and
retrieving files matching the retrieval condition by comparing the generated token with file information included in at least one file to be retrieved.

13. The method according to claim 12, wherein the retrieval menu screen comprises:
a plurality of retrieval fields which are classified for retrieval; and
a plurality of areas to receive input of the retrieval condition corresponding to each retrieval field.

14. The method according to claim 13, wherein the generating of the token comprises:
calculating a final hash value by hashing the retrieval condition which is input into at least one retrieval field from among the plurality of retrieval fields; and
generating the token by combining the calculated final hash value and an identifier of the retrieval field corresponding to the retrieval condition.

15. The method according to claim 13, wherein the generating of the token comprises:
if a plurality of retrieval conditions are input, calculating a temporary hash value for each retrieval condition;
calculating the final hash value by applying a logical operation to each calculated temporary hash value; and
generating the token by combining the calculated final hash value and the identifier of the retrieval field corresponding to each retrieval condition.

16. The method according to claim 15, wherein the local operation is one of an XOR operation and an OR operation selectable by a user.

17. The method according to claim 12, further comprising, when the at least one file is stored in a secure mode:
generating and displaying a security menu screen, the security menu screen comprising a plurality of retrieval fields used in the retrieval mode and a plurality of areas to receive input of detailed information corresponding to each retrieval field;
receiving input of detailed information into the at least one retrieval field;
generating the file information according to each retrieval field by hashing the detailed information input into the at least one retrieval field of the plurality of retrieval fields;
adding the file information generated according to each retrieval field to the at least one file; and
storing the at least one file to which the file information is added.

18. The method according to claim 17, further comprising, if the at least one file is stored in an advanced secure mode:
generating a random number and adding the generated random number to the at least one file; and
generating the file information for each retrieval field by hashing the generated random number and the detailed information input into the at least one retrieval field of the plurality of retrieval fields.

19. The method according to claim 18, wherein the generating of the token comprises:
calculating a final hash value by hashing the retrieval condition input into at least one retrieval field from among the plurality of retrieval fields, and the random number which is added to the at least one file; and
generating the token by combining the calculated final hash value and the identifier of the retrieval field corresponding to the retrieval condition.

20. The method according to claim 14, wherein the retrieving of the files comprises:
identifying the identifier of the retrieval field which is included in the token; and
comparing the final hash value included in the token and the file information of a retrieval field corresponding to the identified identifier in the at least one file.

21. The method according to claim 20, further comprising:
receiving a signal requesting storage of the at least one file in the secure mode and/or a signal requesting retrieval of the at least one file,
selectively displaying the security menu screen and/or the retrieval menu screen in response to the received request signal.
